(19) United States
(12) Patent Application Publication
(10) Pub. No.: US 2011/0043152 A1
(43) Pub. Date: Feb. 24, 2011

(54) DRIVE CONTROL DEVICE

(75) Inventors: Hiroyasu Kidokoro, Kariya-city (JP); Hideki Kabune, Nagoya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/861,166

(22) Filed: Aug. 23, 2010

(30) Foreign Application Priority Data
Aug. 24, 2009 (JP) 2009-192880

(51) Int. Cl. H02H 7/122

(52) U.S. Cl. 318/490

(57) ABSTRACT

A device for driving a motor includes inverters, an interrupter, and a controller. Each inverter includes supply systems. Each supply system includes a power source-side path branching from a power source, a power source-side semiconductor switch located in the power source-side path, a ground-side path branching from a ground, a ground-side semiconductor switch located in the ground-side path, and a motor-side path branching at a connection point between the power source-side path and the ground-side path to supply electric current to a corresponding phase of the motor. The controller controls the motor by controlling the inverters and determines whether the semiconductor switches in each inverter are short-circuited. The controller causes the interrupter to disconnect the supply systems in the inverter having the semiconductor switch that is determined to be short-circuited. The controller continues to control the motor by controlling the other inverter.

### CROSS REFERENCE TO RELATED APPLICATION

This application is based on and incorporates herein by reference Japanese Patent Application No. 2009-192880 filed on Aug. 24, 2009.

### FIELD OF THE INVENTION

The present invention relates to a drive control device for driving and controlling an electric motor.

### BACKGROUND OF THE INVENTION

An electric motor has windings of multiple phases. For example, an electric motor has a three-phase winding set including a U-phase winding, a V-phase winding, and a W-phase winding. To drive such an electric motor, the windings are supplied with electrical currents of the respective phases. Switching of the electrical currents is performed by a drive circuit.

The drive circuit includes an inverter connected to the windings of the motor. For example, the inverter has pairs of MOSFETs corresponding to the respective phases. The switching of the electrical currents is performed by turning ON and OFF the MOSFETs.

JP-A-3-36991 discloses a motor drive device including multiple systems. Each system has an inverter and a winding set corresponding to the inverter. FIG. 1 of JP-A-3-36991 shows two independent systems. Thus, even when one system fails, a motor can be driven by the other system.

In a technique disclosed in JP-A-3-36991, the failed system is disconnected from a power source. The present inventors find out that a problem may remain despite the disconnection of the failed system from the power source, if the system fails due to a short-circuit in a MOSFET. The problem is discussed below with reference to FIG. 9.

FIG. 9 shows a drive control device including two inverters 10, 20. Assuming that a MOSFET 11 in the inverter 10 is short-circuited, an interruption switch 121 may be turned OFF to disconnect the inverter 10 from a power source 50.

However, when the interruption switch 121 is turned OFF, a closed path (i.e., loop) from a node A1 back to the node A1 through a node B1, a motor 60, a node B2, and a node A2 can be formed. Thus, the inverter 10 causes the motor 60 to serves as a generator, when the inverter 20 drives the motor 60. As a result, the motor 60 is braked, and an efficiency of the motor 60 is reduced.

In this way, a closed path can be formed in the failed inverter despite the disconnection of the failed inverter from the power source. The closed path can reduce the efficiency of the motor.

### SUMMARY OF THE INVENTION

In view of the above, it is an object of the present invention to provide a drive control device for efficiently and continuously driving a motor in the event of a short-circuit in an inverter.

According to an aspect of the present invention, a device for driving a motor includes N inverters, an interrupter, and a controller, where N is an integer more than one. Each inverter includes M supply systems, where M is an integer more than one. Each supply system includes a power source-side path branching from a power source, a power source-side semiconductor switch located in the power source-side path, a ground-side path branching from a ground, a ground-side semiconductor switch located in the ground-side path, and a motor-side path branching at a connection point between the power source-side path and the ground-side path to supply electric current to a corresponding phase of the motor. The interrupter is configured to disconnect the supply systems in each inverter. The controller is configured to control the motor by controlling the inverters and configured to determine whether the power source-side semiconductor switch and the ground-side semiconductor switch in each inverter are short-circuited. The controller causes the interrupter to disconnect the supply systems of a first one of the inverters and continues to control the motor by controlling the others of the inverters. At least one of the power source-side semiconductor switch and the ground-side semiconductor switch of the first one of the inverters is determined to be short-circuited.

### BRIEF DESCRIPTION OF THE DRAWINGS

The above and other objectives, features and advantages of the present invention will become more apparent from the following detailed description made with check to the accompanying drawings. In the drawings:

FIG. 1 is a block diagram of a drive control device according to a first embodiment of the present invention;

FIG. 2 is a circuit diagram of an inverter in the drive control device of FIG. 1;

FIG. 3 is a circuit diagram of an inverter in a drive control device according to a second embodiment of the present invention;

FIG. 4 is a circuit diagram of an inverter in a drive control device according to a third embodiment of the present invention;

FIG. 5 is a circuit diagram of an inverter in a drive control device according to a fourth embodiment of the present invention;

FIG. 6 is a circuit diagram of an inverter in a drive control device according to a fifth embodiment of the present invention;

FIG. 7 is a circuit diagram of an inverter in a drive control device according to a modification of the fifth embodiment;

FIG. 8 is a diagram illustrating a partial view of a drive control device according to a modification of the first embodiment; and

FIG. 9 is a circuit diagram of an inverter in a drive control device according to a related art.

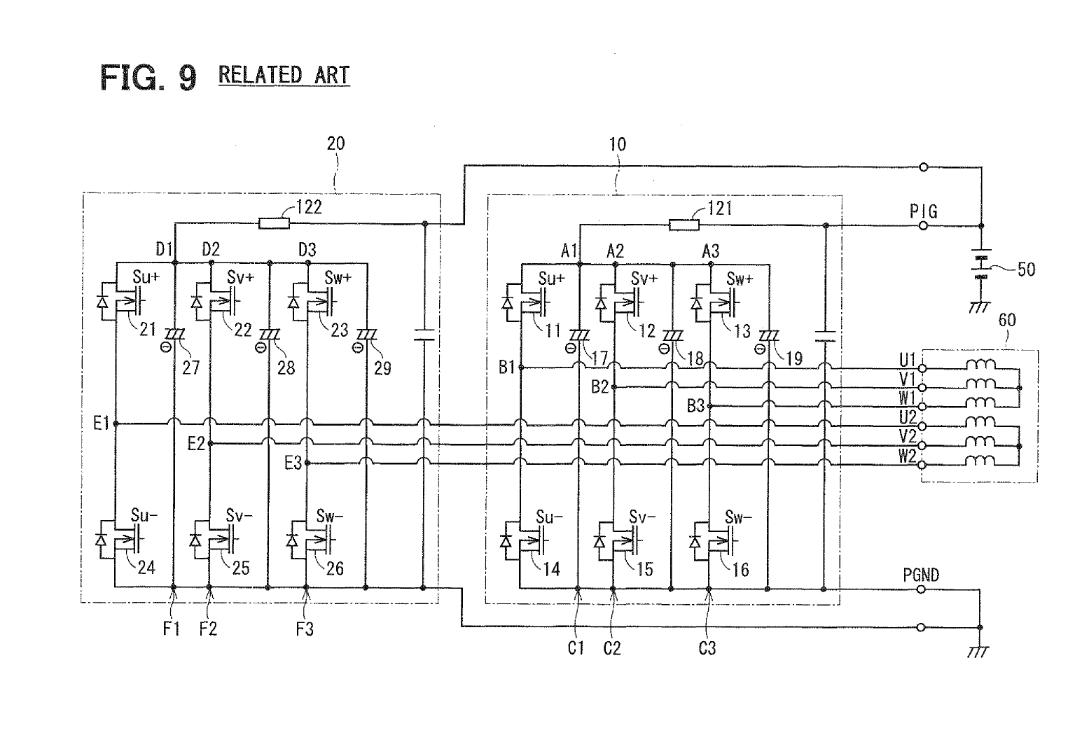

### DETAILED DESCRIPTION OF THE PREFERRED EMBODIMENTS

Embodiments of the present invention are described below with reference to the drawings.

### First Embodiment

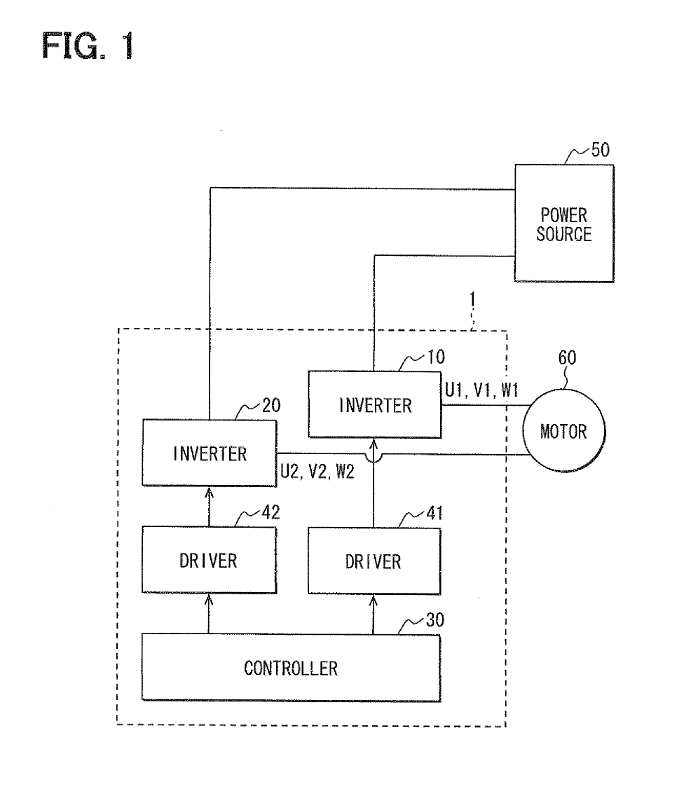

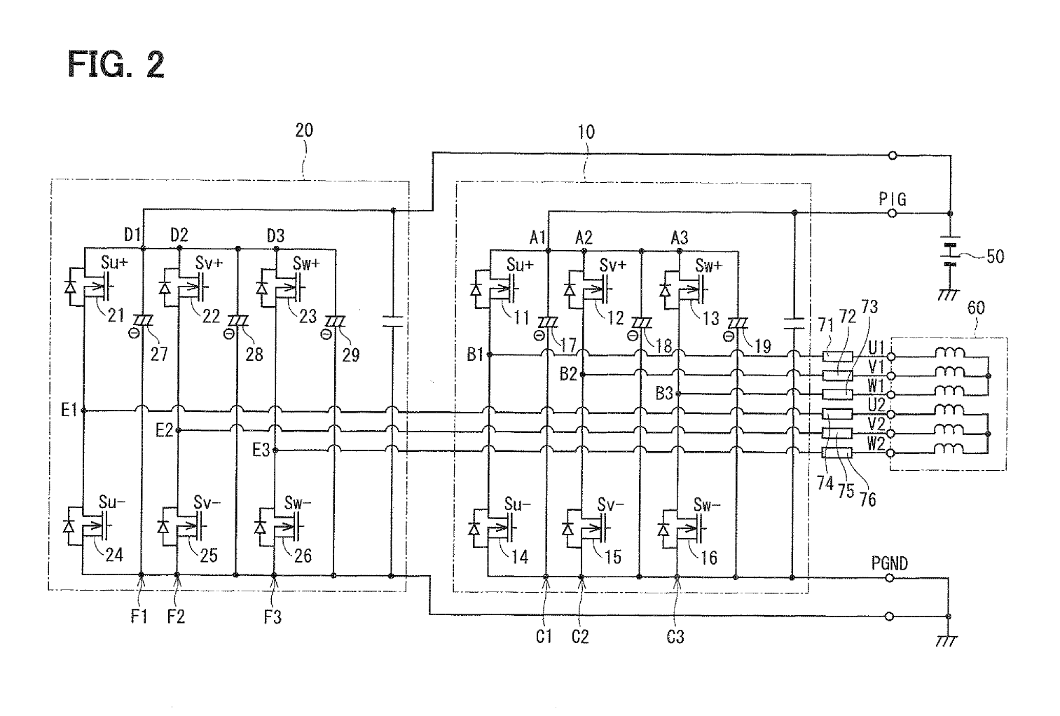

A drive control device 1 according to a first embodiment of the present invention is described below with reference to FIGS. 1 and 2. The drive control device 1 can be used for electric power steering (EPS) of a vehicle. In the EPS, an electric motor 60 rotates based on a vehicle speed signal and a steering torque signal so as to provide steering assist to a driver of the vehicle. The drive control device 1 drives and controls the motor 60.

As shown in FIG. 1, the drive control device 1 includes a first inverter 10, a second inverter 20, a first driver 41, a second driver 42, and a controller 30.

The first and second inverters 10, 20 are connected to a power source 50. The motor 60 has a first three-phase winding set and a second three-phase winding set. The first three-phase winding set includes a first U-phase winding U1, a first V-phase winding V1, and a first W-phase winding W1. The second three-phase winding set includes a second U-phase winding U2, a second V-phase winding V2, and a second W-phase winding W2. The first inverter 10 supplies electric current to the first three-phase winding set. The second inverter 20 supplies electric current to the second three-phase winding set.

The controller 30 includes a microcomputer and controls the motor 60 by controlling the first and second inverters 10, 20. The controller 30 receives the steering torque signal from a torque sensor (not shown) that is mounted on a column shaft of the vehicle. Further, the controller 30 receives the vehicle speed signal via controller area network (CAN). Based on the steering torque signal and the vehicle speed signal, the controller 30 controls the motor 60 by controlling the first and second inverters 10, 20 through the first and second drivers 41, 42, respectively.

Next, the first and second inverters 10, 20 are discussed in detail. As shown in FIG. 2, the first inverter 10 includes six metal-oxide semiconductor field-effect transistors (MOSFETs) 11-16.

The MOSFETs 11-16 are semiconductor switches. Specifically, in each of the MOSFETs 11-16, a conducting channel between source and drain is opened (ON) and closed (OFF) in accordance with a gate potential. Although not shown in the drawings, a gate drive signal is supplied to gate from the controller 30 through the first driver 41.

The MOSFETs 11-13 are connected to a power source side, and the MOSFETs 14-16 are connected to a ground side. The MOSFETs 11-13 are paired with the MOSFETs 14-16, respectively. In FIG. 2, the MOSFETs 11-16 are labeled as “Su+”, “Sv+”, “Sw+” “Su−”, “Sv−”, and “Sw−”, respectively, to distinguish them from each other.

As shown in FIG. 2, the MOSFET 11 as a power source-side semiconductor switch is located in a power source-side path “A1-B1”. The MOSFET 14 as a ground-side semiconductor switch is located in a ground side path “B1-C1”.

A path extending toward the motor 60 from a node B1 between the power source-side path “A1-B1” and the ground-side path “B1-C1” is herein defined as a “motor-side path B1”.

Likewise, the MOSFET 12 as a power source-side semiconductor switch is located in a power source-side path “A2-B2”. The MOSFET 15 as a ground-side semiconductor switch is located in a ground-side path “B2-C2”. A path extending toward the motor 60 from a node B2 between the power source-side path “A2-B2” and the ground-side path “B2-C2” is herein defined as a “motor-side path B2”.

Likewise, the MOSFET 13 as a power source-side semiconductor switch is located in a power source-side path “A3-B3”. The MOSFET 16 as a ground-side semiconductor switch is located in a ground-side path “B3-C3”. A path extending toward the motor 60 from a node B3 between the power source-side path “A3-B3” and the ground-side path “B3-C3” is herein defined as a “motor-side path B3”.

The power source-side path “A1-B1”, the MOSFET 11, the ground-side path “B1-C1”, the MOSFET 14, and the motor-side path B1 form a first supply system.

The power source-side path “A2-B2”, the MOSFET 12, the ground-side path “B2-C2”, the MOSFET 15, and the motor-side path B2 form a second supply system.

The power source-side path “A3-B3”, the MOSFET 13, the ground-side path “B3-C3”, the MOSFET 16, and the motor-side path B3 form a third supply system.

The motor-side path B1 is connected through an interruption switch 71 to the first U-phase winding U1 of the motor 60. The motor-side path B2 is connected through an interruption switch 72 to the first V-phase winding V1 of the motor 60. The motor-side path B3 is connected through an interruption switch 73 to the first W-phase winding W1 of the motor 60.

An aluminum electrolytic capacitor 17 is connected parallel to the pair of the MOSFETs 11, 14. An aluminum electrolytic capacitor 18 is connected parallel to the pair of the MOSFETs 12, 15. An aluminum electrolytic capacitor 19 is connected parallel to the pair of the MOSFETs 13, 16.

As can be seen from FIG. 2, the second inverter 20 is configured in the same manner as the first inverter 10. The second inverter 20 includes six MOSFETs 21-26.

The MOSFETs 21-23 are connected to the power source side, and the MOSFETs 24-26 are connected to the ground side. The MOSFETs 21-23 are paired with the MOSFETs 24-26, respectively. In FIG. 2, the MOSFETs 21-26 are labeled as “Su+”, “Sv+”, “Sw+”, “Su−”, “Sv−”, and “Sw−”, respectively, to distinguish them from each other.

In the second inverter 20, a power source-side path “D1-E1”, the MOSFET 21, a ground-side path “E1-F1”, the MOSFET 24, and a motor-side path E1 form a fourth supply system.

A power source-side path “D2-E2”, the MOSFET 22, a ground-side path “E2-F2”, the MOSFET 25, and a motor-side path E2 form a fifth supply system.

A power source-side path “D3-E3”, the MOSFET 23, a ground-side path “E3-F3”, the MOSFET 26, and a motor-side path E3 form a sixth supply system.

The motor-side path E1 is connected through an interruption switch 74 to the second U-phase winding U2 of the motor 60. The motor-side path E2 is connected through an interruption switch 75 to the second V-phase winding V2 of the motor 60. The motor-side path E3 is connected through an interruption switch 76 to the second W-phase winding W2 of the motor 60.

An aluminum electrolytic capacitor 27 is connected parallel to the pair of the MOSFETs 21, 24. An aluminum electrolytic capacitor 28 is connected parallel to the pair of the MOSFETs 22, 25. An aluminum electrolytic capacitor 29 is connected parallel to the pair of the MOSFETs 23, 26.

As mentioned previously, the controller 30 shown in FIG. 1 receives the steering torque signal from the torque sensor and the vehicle speed signal through the CAN. Further, the controller 30 receives a position signal indicative of a rotational position of the motor 60. When receiving the steering torque signal and the vehicle speed signal, the controller 30 controls the first and second inverters 10, 20 through the drivers 41, 42 in accordance with the position signal, thereby providing the steering assist according to the vehicle speed. Specifically, the first and second inverters 10, 20 are controlled by turning ON and OFF the MOSFETs 11-16 and 21-26. Further, the controller 30 detects electric current flowing through the ground-side MOSFETs 14-16 and 24-26 and controls the first and second inverters 10, 20 in such a manner that a waveform of the electric current supplied to the motor 60 becomes sinusoidal.

Further, according to the first embodiment, the controller 30 is configured to detect a short-circuit failure in each of the MOSFETs 11-16 and 21-26. That is, the controller 30 is configured to determine whether the MOSFETs 11-16 and 21-26 are short-circuited. It is noted that a MOSFET, in which the short-circuit failure occurs, remains ON continuously.

In each MOSFET pair, the power source-side MOSFET and the ground-side MOSFET are exclusively controlled. For example, when the MOSFET 11 is ON, the MOSFET 14 is OFF, and when the MOSFET 11 is OFF, the MOSFET 14 is ON.

For example, when the power source-side MOSFET 11 is short-circuited, excessive current (i.e., overcurrent) flows through a path from the node A1 to the node C1 by way of the node B1 at the moment the ground-side MOSFET 14 is turned ON. Therefore, whether the power source-side MOSFET 11 is short-circuited can be determined by measuring electric current flowing through the ground-side MOSFET 14. In this way, the controller 30 determines whether the MOSFETs 11-16 and 21-26 are short-circuited by measuring electric currents flowing through the ground-side MOSFETs 14-16 and 24-26.

When the controller 30 determines that any one of the MOSFETs 11-16 and 21-26 is short-circuited, the controller 30 turns OFF the three interruption switches corresponding to the inverter having the short-circuited MOSFET. For example, when the controller 30 determines that the MOSFET 11 is short-circuited, the controller 30 turns OFF the three interruption switches 71-73 corresponding to the first inverter 10 having the short-circuited MOSFET 11. In this case, the controller 30 continues to drive the motor 60 by controlling the second inverter 20.

As described above, according to the first embodiment, the interruption switches 71-76 are located in the motor-side paths B1-B3 and E1-E3, respectively. For example, when any one of the MOSFETs 11-16 in the first inverter 10 is short-circuited, all the three interruption circuits 71-73 corresponding to the first inverter 10 are turned OFF. Thus, the first inverter 10 is completely disconnected from the motor 60 so that the motor 60 can be prevented from being braked. Therefore, even when the short-circuit failure occurs in the first inverter 10, the motor 60 can be continuously, efficiently driven by the second inverter 20.

In contrast, when any one of the MOSFETs 21-26 in the second inverter 20 is short-circuited, all the three interruption circuits 74-76 corresponding to the second inverter 20 are turned OFF. Thus, the second inverter 20 is completely disconnected from the motor 60 so that the motor 60 can be prevented from being braked. Therefore, even when the short-circuit failure occurs in the second inverter 20, the motor 60 can be continuously, efficiently driven by the first inverter 10.

For example, the interruption switches 71-76 can be formed with MOSFETs, relays, or the like.

According to the first embodiment, the interruption switches 71-76 are located in the six motor-side paths of the first and second inverters 10, 20, respectively. In other words, each of all of the three motor-side paths in each inverter is provided with the interruption switch. Alternatively, each of two of the three motor-side paths in each inverter can be provided with the interruption switch. A reason for this is that when two of the three motor-side paths in each inverter are disconnected, a closed path (i.e., loop) is not formed.

However, for example, if there is no interruption switch 71 in the motor-side path B, a closed path may be formed when any one of the interruption switches 72, 73 is short-circuited. Therefore, it is preferable that each of all of the three motor-side paths in each inverter should be provided with the interruption switch.

### Second Embodiment

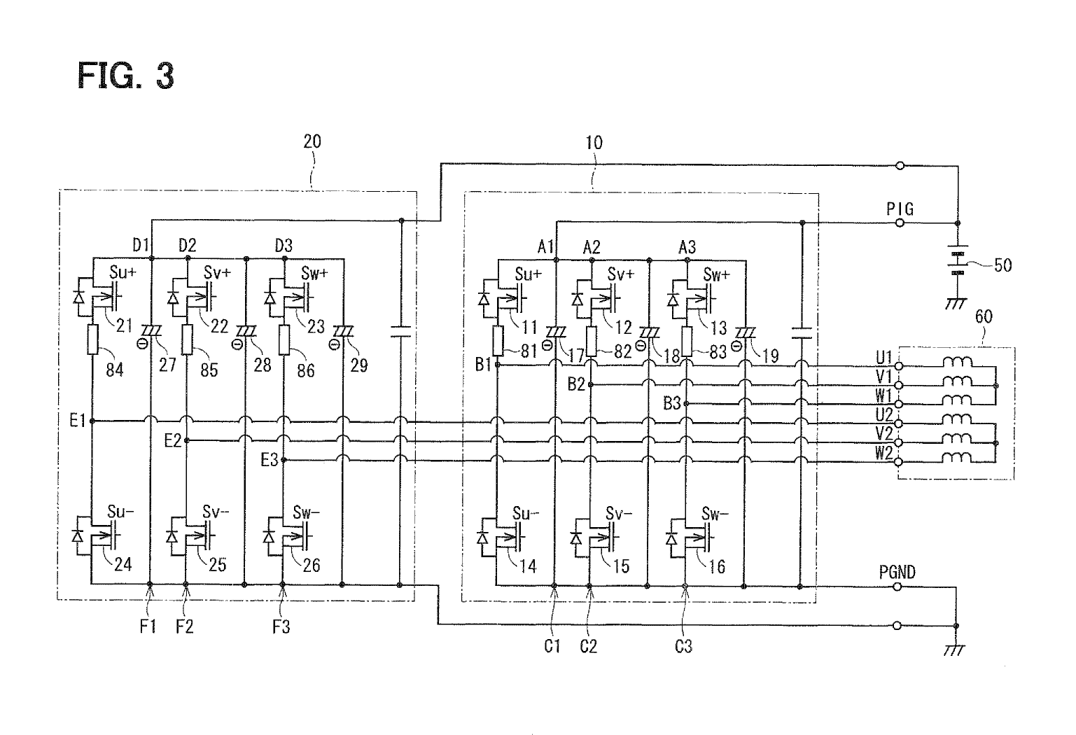

A second embodiment of the present invention is described below with reference to FIG. 3. A difference of the second embodiment from the first embodiment is in that the interruption switches 71-76 are replaced with interruption switches 81-86.

As shown in FIG. 3, the interruption switch 81 is located in the power source-side path “A1-B1” in the first inverter 10. The interruption switch 82 is located in the power source-side path “A2-82” in the first inverter 10. The interruption switch 83 is located in the power source-side path “A3-B3” in the first inverter 10. The interruption switch 84 is located in the power source-side path “D1-E1” in the second inverter 20. The interruption switch 85 is located in the power source-side path “D2-E2” in the second inverter 20. The interruption switch 86 is located in the power source-side path “D3-E3” in the second inverter 20. In such an approach, a closed path is not formed by a combination of the power source-side path and the motor-side path.

The interruption switches 81-86 can be formed with MOSFETs, relays, fuses, or the like. Assuming that the interruption switches 81-86 are formed with fuses, the controller 30 turns ON not only a MOSFET paired with a short-circuited MOSFET but also all the other MOSFETs in an inverter having the short-circuited MOSFET, thereby causing corresponding fuses to blow. For example, when the MOSFET 11 in the first inverter 10 is short-circuited, the controller 30 turns ON all the other MOSFETs 12-16 in the first inverter 10 having the short-circuited MOSFET 11 so that the corresponding fuses 81-83 can blow. For another example, when the MOSFET 21 in the second inverter 20 is short-circuited, the controller 30 turns ON all the other MOSFETs 22-26 in the second inverter 20 having the short-circuited MOSFET 21 so that the corresponding fuses 84-86 can blow.

According to the second embodiment, the interruption switches 81-86 are located in the six power source-side paths of the first and second inverters 10, 20, respectively. In other words, each of all of the three power source-side paths in each inverter is provided with the interruption switch. Alternatively, each of two of the three power source-side paths in each inverter can be provided with the interruption switch. A reason for this is that when two of the three power source-side paths in each inverter are disconnected, a closed path (i.e., loop) is not formed by a combination of the power-side path and the motor-side path.

However, for example, if there is no interruption switch 81 in the power source-side path “A1-B1”, a closed path may be formed when any one of the interruption switches 82, 83 is short-circuited. Further, for example, if there is no interruption switch 81 in the power source-side path “A1-B1”, excessive current flowing from the node A1 to the node C1 by way of the node B1 may be caused by a short-circuit failure in the MOSFET 14 following a short-circuit failure in the MOSFET 11. Therefore, it is preferable that each of all of the three power source-side paths in each inverter should be provided with the interruption switch.

Shunt resistors for measuring electric currents may be located in the ground-side paths. In such a case, the interruption switches located in the power source-side paths can be balanced with the shunt resistors located in the ground-side paths. Therefore, the second embodiment is suitable for the case where the shunt resistors are located in the ground-side paths.

### Third Embodiment

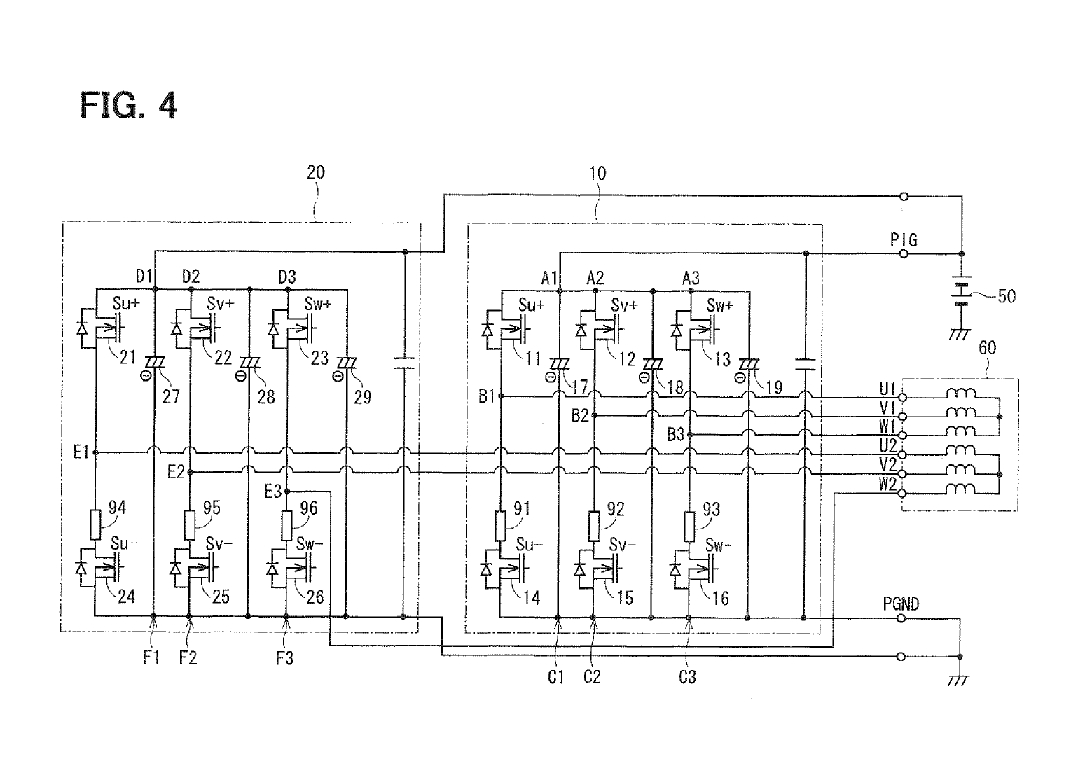

A third embodiment of the present invention is described below with reference to FIG. 4. A difference of the third embodiment from the first embodiment is in that the interruption switches 71-76 are replaced with interruption switches 91-96.

As shown in FIG. 4, the interruption switch 91 is located in the ground-side path “B1-C1” in the first inverter 10. The interruption switch 92 is located in the ground-side path “B2-C2” in the first inverter 10. The interruption switch 93 is located in the ground-side path “B3-C3” in the first inverter 10. The interruption switch 94 is located in the ground-side path “E1-F1” in the second inverter 20. The interruption switch 95 is located in the ground-side path “E2-F2” in the second inverter 20. The interruption switch 96 is located in the ground-side path “E3-F3” in the second inverter 20. In such an approach, a closed path is not formed by a combination of the ground-side path and the motor-side path.

The interruption switches 91-96 can be formed with MOSFETs, relays, fuses, or the like. Assuming that the interruption switches 91-96 are formed with fuses, the controller 30 turns ON not only a MOSFET paired with a short-circuited MOSFET but also all the other MOSFETs in an inverter having the short-circuited MOSFET, thereby causing corresponding fuses to blow. For example, when the MOSFET 11 in the first inverter 10 is short-circuited, the controller 30 turns ON all the other MOSFETs 12-16 in the first inverter 10 having the short-circuited MOSFET 11 so that the corresponding fuses 91-93 can blow. For another example, when the MOSFET 21 in the second inverter 20 is short-circuited, the controller 30 turns ON all the other MOSFETs 22-26 in the second inverter 20 having the short-circuited MOSFET 21 so that the corresponding fuses 94-96 can blow.

According to the third embodiment, the interruption switches 91-96 are located in the six ground-side paths of the first and second inverters 10, 20, respectively. In other words, each of all of the three ground-side paths in each inverter is provided with the interruption switch. Alternatively, each of two of the three ground-side paths in each inverter can be provided with the interruption switch. A reason for this is that when two of the three ground-side paths in each inverter are disconnected, a closed path (i.e., loop) is not formed with a combination of the ground-side path and the motor-side path.

However, for example, if there is no interruption switch 91 in the ground-side path “B1-C1”, a closed path may be formed when any one of the interruption switches 92, 93 is short-circuited. Further, for example, if there is no interruption switch 91 in the ground-side path “B1-C1”, excessive current flowing from the node A1 to the node C1 by way of the node B1 may be caused by a short-circuit failure in the MOSFET 11 following a short-circuit failure in the MOSFET 14. Therefore, it is preferable that each of all of the three ground-side paths in each inverter should be provided with the interruption switch.

Shunt resistors for measuring electric currents may be located in the power source-side paths. In such a case, the interruption switches located in the ground-side paths can be balanced with the shunt resistors located in the power source-side paths. Therefore, the third embodiment is suitable for the case where the shunt resistors are located in the power source-side paths.

### Fourth Embodiment

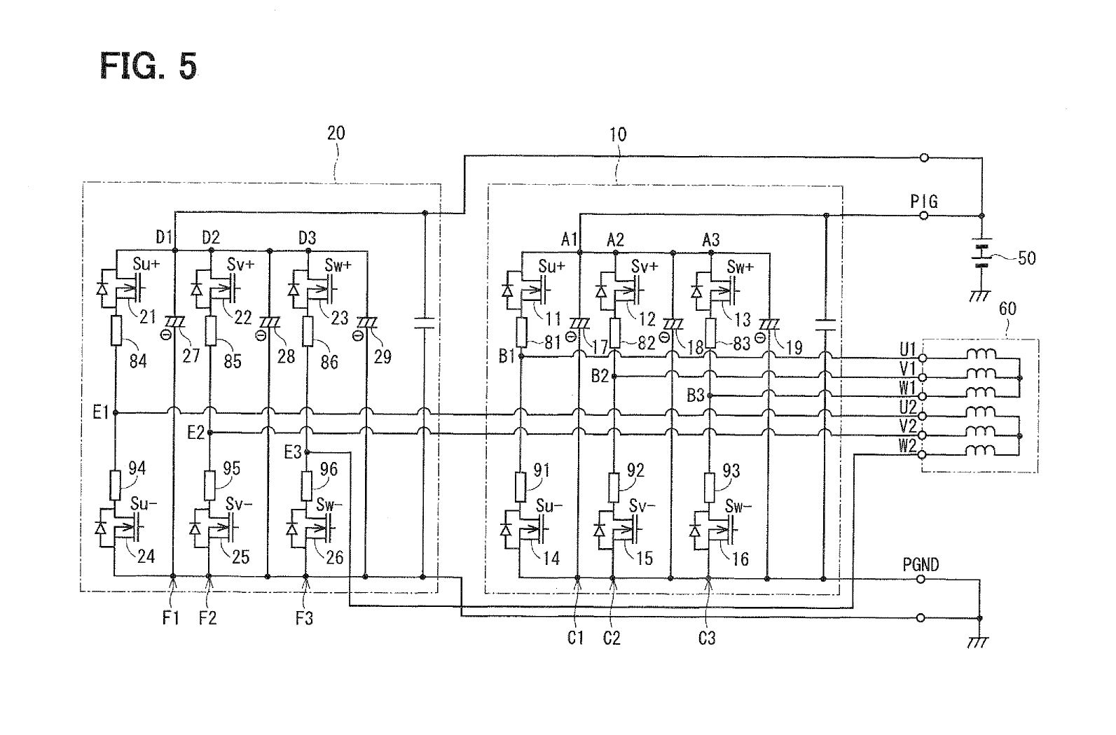

A fourth embodiment of the present invention is described below with reference to FIG. 5. A difference of the fourth embodiment from the preceding embodiments is as follows.

According to the fourth embodiment, as shown in FIG. 5, in the first inverter 10, the interruption switches 81, 82, and 83 are located in the power source-side paths “A1-B1”, “A2-B2”, and “A3-B3”, respectively. Further, the interruption switches 91, 92, and 93 are located in the ground-side paths “B1-C1”, “B2-C2”, and “B3-C3”, respectively.

Likewise, in the second inverter 20, the interruption switches 84, 85, and 86 are located in the power source-side paths “D1-E1”, “D2-E2”, and “D3-E3”, respectively. Further, the interruption switches 94, 95, and 96 are located in the ground-side paths “E1-F1”, “E2-F2”, and “E3-F3”, respectively.

That is, the fourth embodiment corresponds to a combination of the second embodiment and the third embodiment. In such an approach, neither a combination of the power source-side path and the motor-side path nor a combination of the ground-side path and the motor-side path form a closed path.

The interruption switches 81-86, and 91-96 can be formed with MOSFETs, relays, fuses, or the like.

As described above, according to the fourth embodiment, the interruption switches 81-86 are located in the six power source-side paths of the first and second inverters 10, 20, respectively. In other words, each of all of the three power source-side paths in each inverter is provided with the interruption switch. Alternatively, each of two of the three power source-side paths in each inverter can be provided with the interruption switch. A reason for this is that when two of the three power source-side paths in each inverter are disconnected, a closed path (i.e., loop) is not formed by a combination of the power-side path and the motor-side path.

However, for example, if there is no interruption switch 81 in the power source-side path “A1-B1”, a closed path may be formed when any one of the interruption switches 82, 83 is short-circuited. Further, for example, if there is no interruption switch 81 in the power source-side path “A1-B1”, excessive current flowing from the node A1 to the node C1 by way of the node B1 may be caused by a short-circuit failure in the MOSFET 14 following a short-circuit failure in the MOSFET 11. Therefore, it is preferable that each of all of the three power source-side paths in each inverter should be provided with the interruption switch.

Further, according to the fourth embodiment, the interruption switches 91-96 are located in the six ground-side paths of the first and second inverters 10, 20, respectively. In other words, each of all of the three ground-side paths in each inverter is provided with the interruption switch. Alternatively, each of two of the three ground-side paths in each inverter can be provided with the interruption switch. A reason for this is that when two of the three ground-side paths in each inverter are disconnected, a closed path (i.e., loop) is not formed with a combination of the ground-side path and the motor-side path.

However, for example, if there is no interruption switch 91 in the ground-side path “B1-C1”, a closed path may be formed when any one of the interruption switches 92, 93 is short-circuited. Further, for example, if there is no interruption switch 91 in the ground-side path “B1-C1”, excessive current flowing from the node A1 to the node C1 by way of the node B1 may be caused by a short-circuit failure in the MOSFET 11 following a short-circuit failure in the MOSFET 14. Therefore, it is preferable that each of all of the three ground-side paths in each inverter should be provided with the interruption switch.

### Fifth Embodiment

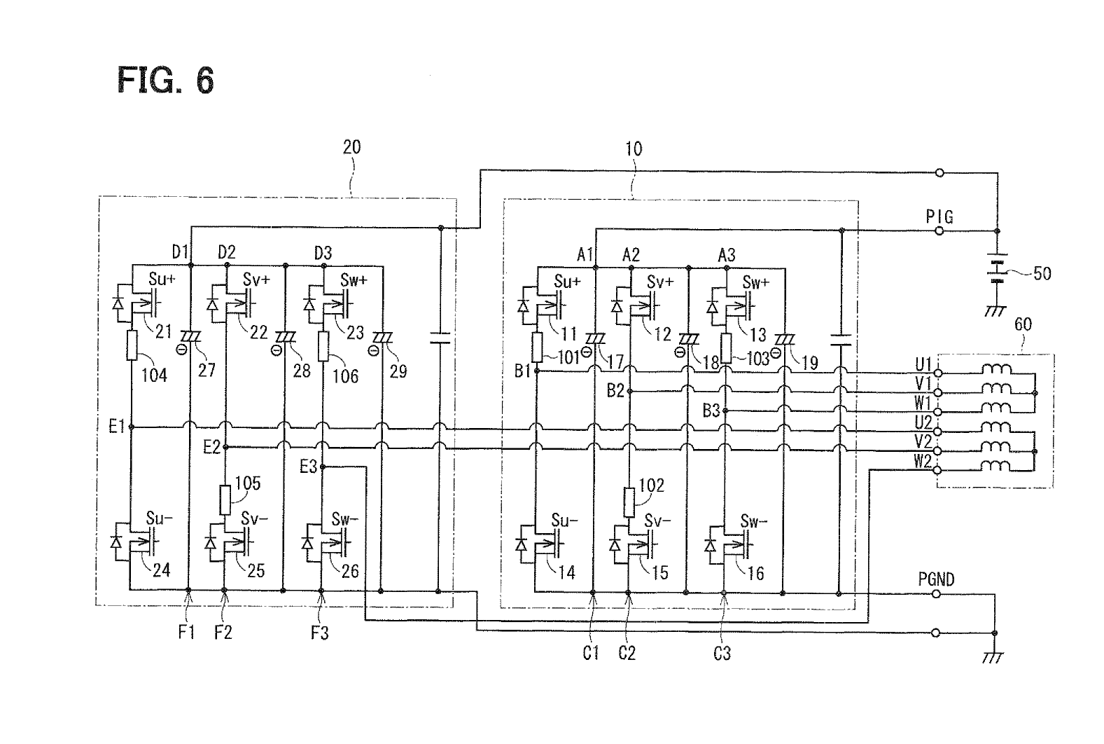

A fifth embodiment of the present invention is described below with reference to FIG. 6. A difference of the fourth embodiment from the preceding embodiments is as follows.

According to the fifth embodiment, as shown in FIG. 6, in the first inverter 10, interruption switches 101, 102, and 103 are located in the power source-side path “A1-B1”, the ground-side path “B2-C2”, and the power source-side path “A3-B3”, respectively.

Likewise, in the second inverter 20, interruption switches 104, 105, and 106 are located in the power source-side path “D1-E1”, the ground-side path “E2-F2”, and the power source-side path “D3-E3”, respectively.

In such an approach, it is possible to prevent a closed path from being formed. However, for example, if the MOSFET 14 in the first inverter 10 is short-circuited, a closed path from the node B1 back to the node B1 by way of the node C1, the node C3, the node B3, and the motor 60 is formed. Therefore, the configuration shown in FIG. 6 can handle only a short-circuit failure in the MOSFETs 11, 15, 13, 21, 25, and 23 corresponding to the paths provided with the interruption switches 101-106, respectively.

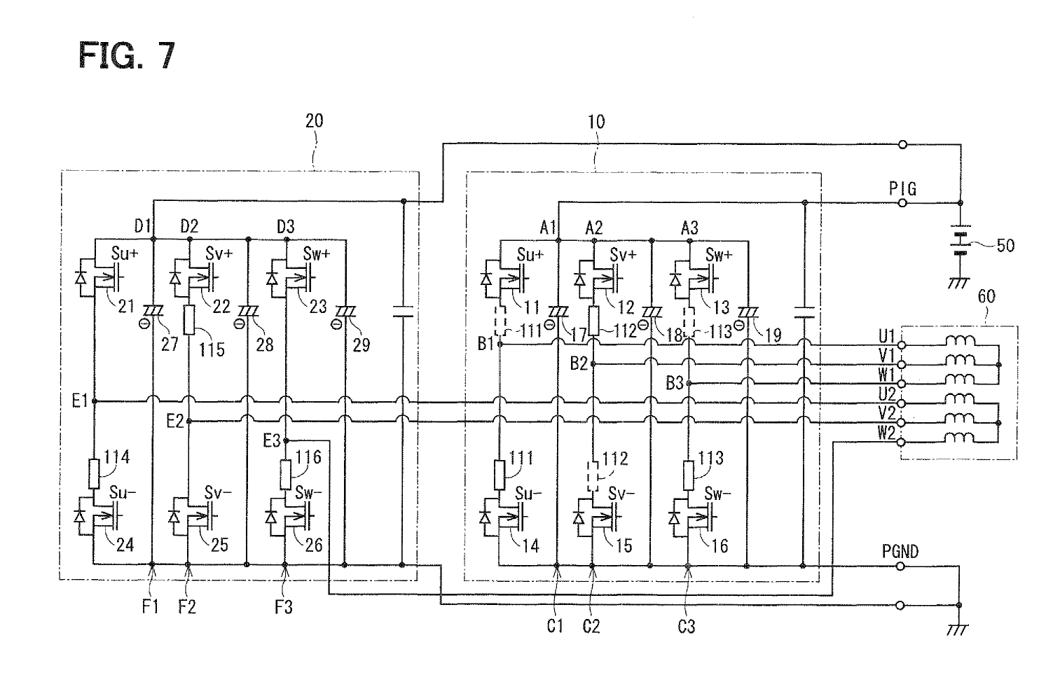

For example, the fifth embodiment can be modified as shown in FIG. 7. According to the modification shown in FIG. 7, in the first inverter 10, interruption switches 111, 112, and 113 are located in the ground-side path “B1-C1”, the power source-side path “A2-B2”, and the ground-side path “B3-C3”, respectively. In the second inverter 20, interruption switches 114, 115, and 116 are located in the ground-side path “E1-F1”, the power source-side path “D2-E2”, and the ground-side path “E3-F3”, respectively.

Alternatively, as indicated by broken arrows in FIG. 7, the interruption switches 111, 112, and 113 can be located in the power source-side path “A1-B1”, the ground-side path “B2-C2”, and the power source-side path “A3-B3. That is, the interruption switches 111-113 in the first inverter 10 can be alternately with respect to the interruption switches 114-116 in the second inverter 20. In such an approach, even when a short-circuit failure occurs in one of the first and second inverters 10, 20, the one of the first and second inverters 10, 20 can continue to be controlled to drive the motor 60.

The interruption switches 101-106 (111-116) can be formed with MOSFETs, relays, fuses, or the like. Assuming that the interruption switches 101-106 (111-116) are formed with fuses, the controller 30 turns ON not only a MOSFET paired with a short-circuited MOSFET but also all the other MOSFETs in an inverter having the short-circuited MOSFET, thereby causing corresponding fuses to blow. For example, when the MOSFET 11 in the first inverter 10 is short-circuited, the controller 30 turns ON all the other MOSFETs 12-16 in the first inverter 10 having the short-circuit MOSFET 11 so that the corresponding fuses 101-103 (111-113) can blow. For another example, when the MOSFET 21 in the second inverter 20 is short-circuited, the controller 30 turns ON all the other MOSFETs 22-26 in the second inverter 20 having the short-circuit MOSFET 21 so that the corresponding fuses 104-106 (114-116) can blow.

### Modifications

The embodiments described above can be modified in various ways, for example, as follows.

In the first embodiment, since the interruption switches 71-76 are located in the motor-side paths, it is difficult to cause the interruption switches 71-76 to blow by excessive currents. Therefore, it is not preferable that the interruption switches 71-76 should be formed with fuses.

Alternatively, interruption switches located in the motor-side path can be caused to blow like a fuse by placing the interruption switches adjacent to the nodes B1-B3 and E1-E3, respectively.

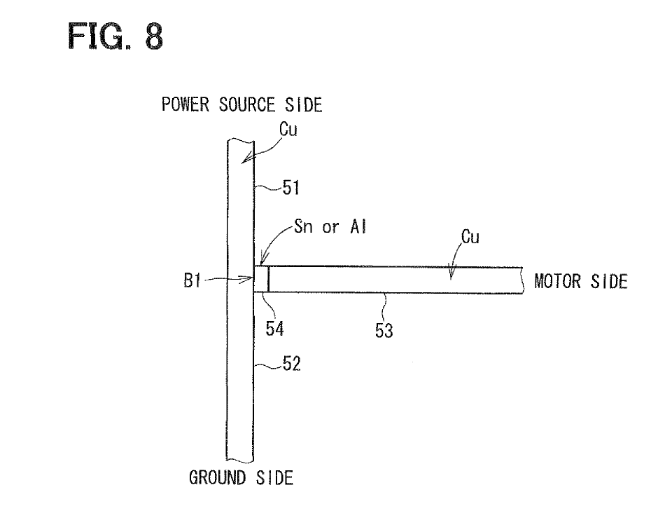

For example, in a modification shown in FIG. 8, a power source-side path 51, a ground-side path 52, and a motor-side path 53 are made of copper (Cu), and the motor-side path 53 has a fuse portion 54 located adjacent to the node B1. The fuse portion 54 is made of tin (Sn), aluminum (Al), or the like. It is noted that a predetermined tension is applied to the motor-side path 53 so that the motor-side path 53 can be pulled in a direction away from the node 131. In such an approach, the fuse portion 54 can blow by excessive current flowing from the power source-side path 51 to the ground-side path 52 so that the motor-side path 53 can be disconnected from the node B1.

In the embodiments, the drive control device 1 has two inverters 10, 20. Alternatively, the drive control device 1 can have more than two inverters.

In the embodiments, each of the first and second inverters 10, 20 has three supply systems. Alternatively, each of the first and second inverters 10, 20 can have at least two supply systems.

In the embodiments, an electric current is supplied to a set of three-phase windings including a U-phase, a V-phase, and a W-phase by using three supply systems. Alternatively, an electric current can be supplied to multiple sets of three-phase windings by using three supply systems.

In the embodiments, a short-circuit failure is determined by detecting excessive current. Alternatively, the short-circuit failure can be determined by monitoring an intermediate voltage in the motor 60. Alternatively, the short-circuit failure can be determined by monitoring a voltage at a predetermined point before driving the motor 60.

In the embodiments, the motor 60 is configured as a motor with a built-in electronic circuit (i.e., the drive control device 1) and used for electric power steering (EPS) of a vehicle. Alternatively, the motor 60 can be used for a system other than EPS. For example, the motor 60 can be used for a wiper system, a valve timing adjusting system, or the like.

Such changes and modifications are to be understood as being within the scope of the present invention as defined by the appended claims.

What is claimed is:

1. A device for driving a motor, the device comprising:
N inverters, where N is an integer more than one, each inverter including M supply systems, where M is an integer more than one, each supply system including a power source-side path branching from a power source, a power source-side semiconductor switch located in the power source-side path, a ground-side path branching from a ground, a ground-side semiconductor switch located in the ground-side path, and a motor-side path branching at a connection point between the power source-side path and the ground-side path to supply electric current to a corresponding phase of the motor;
an interrupter configured to disconnect the supply systems in each inverter; and
a controller configured to control the motor by controlling the inverters and configured to determine whether the power source-side semiconductor switch and the ground-side semiconductor switch in each inverter are short-circuited, wherein
the controller causes the interrupter to disconnect the supply systems of a first one of the inverters and continues to control the motor by controlling the others of the inverters, and
at least one of the power source-side semiconductor switch and the ground-side semiconductor switch of the first one of the inverters is determined to be short-circuited.

2. The device according to claim 1, wherein
the motor-side path of each of M−1 of the M supply systems has the interrupter.

3. The device according to claim 2, wherein
the motor-side path of each of the M supply systems has the interrupter.

4. The device according to claim 1, wherein
the power source-side path of each of M−1 of the M supply systems has the interrupter.

5. The device according to claim 4, wherein
the power source-side path of each of the M supply systems has the interrupter.

6. The device according to claim 1, wherein
the ground-side path of each of M−1 of the M supply systems has the interrupter.

7. The device according to claim 6, wherein
the ground-side path of each of the M supply systems has the interrupter.

8. The device according to claim 1, wherein
the power source-side path or the ground-side path of each of the M supply systems has the interrupter.

9. The device according to claim 1, wherein
the interrupter is turned OFF in response to a control signal from the controller so as to disconnect the supply systems.

10. The device according to claim 1, wherein
the interrupter blows due to excessive current flowing through the power source-side path and the ground-side path so as to disconnect the supply systems.

11. The device according to claim 10, wherein
the excessive current is caused by turning ON the other of the power source-side semiconductor switch and the ground-side semiconductor switch of the first one of the supply systems of the first one of the inverters.

12. The device according to claim 10, wherein
the excessive current is caused by turning ON the power source-side semiconductor switch and the ground-side semiconductor switch of each of the others of the supply systems of the first one of the inverters.

13. The device according to claim 10, wherein
the interrupter is located at the connection point between the power source-side path and the ground-side path, and
the motor side-path is disconnected from the connection point when the interrupter blows.
